(19) United States
(12) Patent Application Publication
(10) Pub. No.: US 2003/0131444 A1
(43) Pub. Date: Jul. 17, 2003

(54) Caster with ball

(76) Inventor: Minoru Koguchi, Toda-Shi (JP)

Correspondence Address: Minoru Koguchi, 3-3-4 KAMITODA, TODA-Shi, SAITAMA-Ken, 335-0022, JP

(21) Appl. No.: 10/036,891

(22) Filed: Jan. 4, 2002

(51) Int. Cl. B60B 33/08

(52) U.S. Cl. 16/24

(57) ABSTRACT

An device for dust avoiding system for a caster with ball used for a supporting branch of medical equipments and the like.

My device on the caster with ball comprising a pipe to maintain a main ball and two spare balls at lower portion of the caster. The pipe has several vertical slits made at its lower end to make the main ball to come inside easily. The pipe is equipped with anti-dust material throughout a entire periphery of its lower end. My present device include a means of removing a main ball and spare balls off the pipe under a fulcrum to clean microscopic dust accumulated inside the pipe of the caster. In this case, hollowness made in said fulcrum is used to suck up said dust through.

This invention has to do with a caster with ball, and more particularly with the caster having anti-dust material throughout a entire periphery of a lower end of the caster.

In the present invention, the anti-dust material is mounted around lower part of a pipe portion of the caster by which the caster can turn round smoothly by preventing dust from entering into space portion of the caster.

Heretofore, there were no such a caster, and dust entered and sticked to inside part of the caster often hinder the caster from turn round smoothly, which has been a big problem.

This invention was made to solve it.

Referring to the drawings;

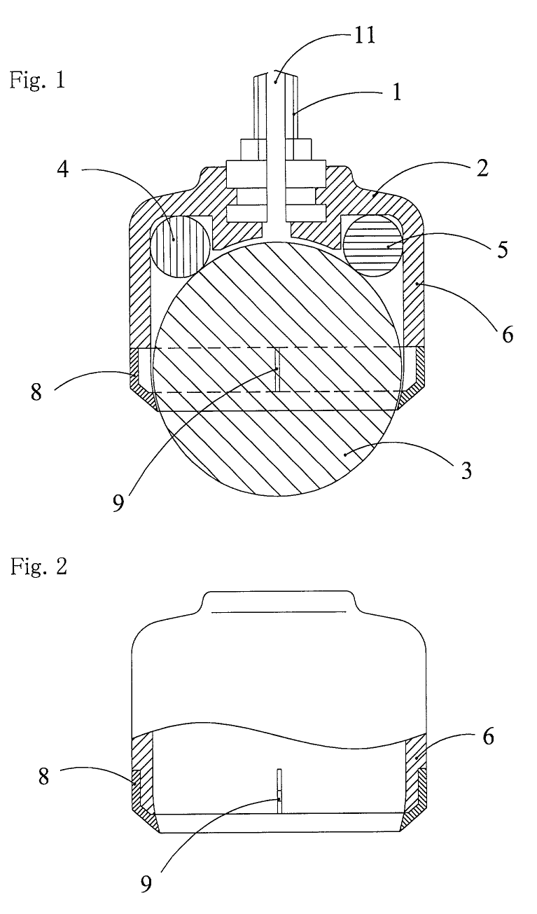

FIG. 1 is a vertical sectional view of the caster of my invention;

FIG. 2 is a front sectional view of the pipe 6; and cross sectional view thereof;

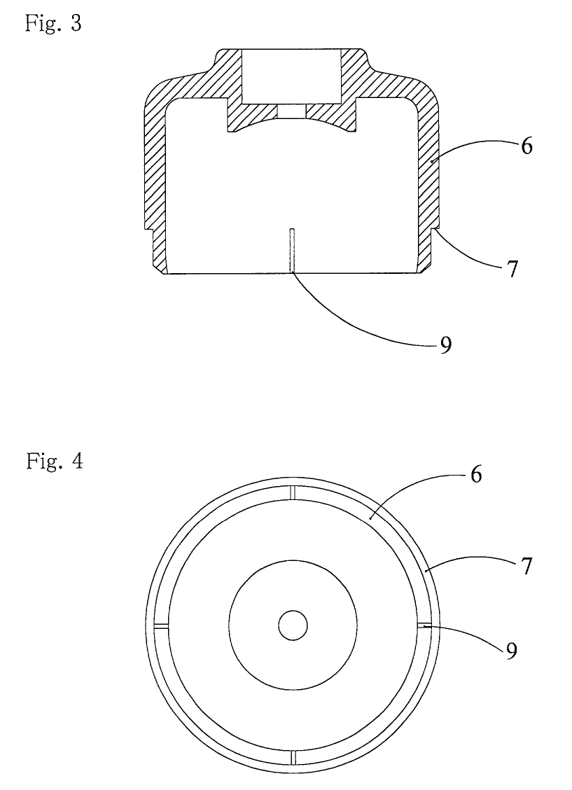

FIG. 3 is a vertical sectional view of the pipe;

FIG. 4 is a bottom plan view of the caster;

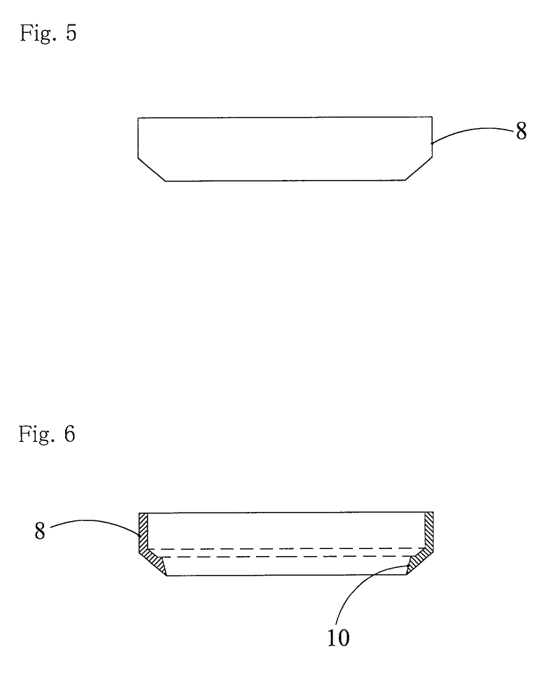

FIG. 5 is a front sectional view of the anti-dust material;

FIG. 6 is a vertical sectional view of the anti-dust material;

FIG. 7 is a vertical sectional view of a inner hole of the fulcrum 1.

### DETAILED DESCRIPTION OF THE INVENTION

The fulcrum 1 is used for the purpose of fixing the caster 2 to a stand or the like.

Spare balls 4 and 5 are used for the purpose of making a ball 3 turn around smoothly, and also the caster 2 move in any direction.

Size for lower part of the pipe 6 needs to be made smaller than diameter of the ball 3, and four slits 9's are made at lower part of the pipe 6 to make the ball 3 to come inside easily.

Space 7 is set at lower surrounding portion of the pipe 6.

Anti-dust material 8 needs to be put around the pipe 6 for the purpose of avoiding dust coming into the pipe 6.

Stainless material is favorable to be used for the fulcrum 1. Plastics are used for anti-dust material 8 since it is strong and flexible. It also can proof against oil.

While a certain preferred embodiment has been shown and described, various other modification will be apparent, and it is all right to to put slice metal on the top of the anti-dust 8 for another additional way of avoiding dust.

It is to be understood that the invention is not limited to the precise embodiment described above and that minor modification may be made within the scope of the invention.

Other objects and advantages will be apparent from following description of one of one practical embodiment of the invention.

Furthermore, to prevent incomplete rotation of ball 3 resulting from microscopic dust accumulated inside the caster 2, it is possible to clean the inside area of the cast by removing the ball 3 and spare balls 4 and 5 off the pipe 6 and then, such up said dust through hollowness 11 in the fulcrum 1.

By the present invention as above described, following advantages were gained.

1. The anti-dust material works well to put off dust.

2. The diameter of the ball 3 is set up 70 mm., hence it can move smoothly even on the rough floor and ditch.

3. The caster can move on the ditch of elevator.

4. Especially for a branch of medical treatment, the present invention will be able to be of great help and more powerful.

What I claim is:

1. The embodiments of the invention in which an exclusive property or privilege is claimed are defined as follows;
A caster with ball comprising a pipe (6) to retain a ball (3), a pipe (6) having slit (9) at its lower part to make the ball (3) to come inside easily, and having anti-dust material (8) throughout a entire periphery of a lower end of said pipe (6), and hollowness (11) deviced in fulcrum (1) to such up microscopic dust accumulated inside the caster (2), a means of removing the ball (3) and spare balls (4) and (5) off the pipe (6) to clean the inside part of the pipe (6).
